(19) United States
(12) Patent Application Publication
(10) Pub. No.: US 2012/0188181 A1
(43) Pub. Date: Jul. 26, 2012

(54) TOUCH SCREEN APPARATUS DETECTING TOUCH PRESSURE AND ELECTRONIC APPARATUS HAVING THE SAME

(75) Inventors: Joo Young HA, Suwon (KR); Sun Mi SIN, Suwon (KR); Jae Kwang LEE, Seongnam (KR); In Cheol CHANG, Seongnam (KR); Ho Seop JEONG, Seongnam (KR)

(73) Assignee: SAMSUNG ELECTROMECHANICS CO., LTD., Suwon (KR)

(21) Appl. No.: 13/340,211

(22) Filed: Dec. 29, 2011

(30) Foreign Application Priority Data
Jan. 25, 2011 (KR) 10-2011-0007271

(51) Int. Cl. G06F 3/041

(52) U.S. Cl. 345/173

(57) ABSTRACT

Disclosed are a touch screen apparatus, in which a plurality of touch areas and touch pressure applied to the plurality of touch areas are sensed, and an electronic apparatus having the same. The touch screen apparatus and the electronic apparatus include a touch pad having pressure applied thereto, a plurality of pressure detectors detecting the pressure applied to the touch pad at different positions, and a touch pressure calculator calculating magnitude of pressure applied to a touch position using distances between the touch position calculated by a difference in detection time of the pressure detected by each of the plurality of pressure detectors and each of the plurality of pressure detectors.

### CROSS-REFERENCE TO RELATED APPLICATIONS

This application claims the priority of Korean Patent Application No. 10-2011-0007271 filed on Jan. 25, 2011, in the Korean Intellectual Property Office, the disclosure of which is incorporated herein by reference.

### BACKGROUND OF THE INVENTION

1. Field of the Invention

The present invention relates to touch screen technology for sensing an area touched on a screen, and more particularly, to a touch screen apparatus sensing a plurality of touch areas and detecting touch pressure applied to the plurality of touch areas and an electronic apparatus having the same.

2. Description of the Related Art

Generally, a touch screen is a user interface device that may obtain touched coordinates when a user's hand or an object is touched to characters or specific coordinates displayed on a display (screen) without using a general interface device, i.e., a keyboard or a mouse and perform a specific process on the obtained coordinates using stored software.

Generally, the touch screen implements its own function by adding a panel for touching (hereinafter, referred to as a touch panel) to a screen. The touch panel has a function in which touch pressure, or the like, is sensed when an object, such as a finger, a stylus, or the like, is touched to the touch panel so as to be able to determine touched coordinates. Further, the touch screen may create user desired results by allowing a computer system, or the like, to process instructions corresponding to the touched coordinates.

As such, the touch screen implements a very intuitive user interface and thus, has been mainly used in a shared unit installed in places (for example, subways, department stores, banks, or the like) having a lot of foot traffic. In addition, the touch screen has been also adopted in a sales terminal in various shops or as a business computer system.

However, touch screens commercialized to date have barely reached a level of technology sufficient to obtain coordinates of positions at which touch pressure is simply applied and transmits the obtained coordinate information to a computer system. That is, the touch screen according to the related art merely obtains the coordinates of touch positions, but does not consider the magnitude of touch pressure.

In addition, when one or more touched points are simultaneously generated on the touch panel, the touch screen according to the related art cannot sense all touched points and obtain the magnitude of pressure applied to each touched point.

### SUMMARY OF THE INVENTION

An object of the present invention provides a touch screen apparatus capable of detecting two or more touched points and obtaining a magnitude of touch pressure applied to each touched point and an electronic apparatus having the same.

According to an exemplary embodiment of the present invention, there is provided a touch screen apparatus detecting touch pressure, including: a touch pad having pressure applied thereto; plurality of pressure detectors detecting the pressure applied to the touch pad at different positions; and a touch pressure calculator calculating magnitude of pressure applied to a touch position using distances between the touch position calculated by a difference in detection time of the pressure detected by each of the plurality of pressure detectors and each of the plurality of pressure detectors.

The touch pressure calculator may include: a mode setting unit setting a single mode calculating magnitude of a single touch pressure or a multi-mode calculating magnitude of a plurality of touch pressures according to a setting signal; a position detector detecting a single touch position or a plurality of touch positions according to the set mode of the mode setting unit; and a pressure level calculator calculating the magnitude of the single touch pressure or the magnitude of the plurality of touch pressures by using distances between the single touch position or the plurality of touch positions and each of the plurality of pressure detectors according to the set mode of the mode setting unit.

The pressure level calculator may calculate the magnitude of pressure applied to the touch position by the following Equation 1 when the number of pressure application positions is one and the number of the pressure detector is n (n is a natural number of 2 or more);

$${F}_{t} = \frac{\frac{1}{{d}_{1}} + \frac{1}{{d}_{2}} + … + \frac{1}{{d}_{n}}}{\frac{1}{{d}_{k}}} {F}_{k} \qquad [ Equation 1 ]$$

in the above Equation 1, Fₜ is the magnitude of pressure applied to the touch position, d₁ to dₙ are distances between the touch position and each of the pressure detectors, k is any number between 1 to n, Fₖ is magnitude of pressure detected by any pressure detector, and dₖ is a distance between any pressure detector and the touch position.

The pressure level calculator may calculate pressure at pressure application positions by a plural equation of the following Equation 2 when the number of the pressure application positions are m (m is a natural number of 2 or more) and the number of the pressure detector is n (n is a natural number of 2 or more);

$${F}_{1} = {F}_{t 1} {R}_{11} + {F}_{t 2} {R}_{21} + … + {F}_{tm} {R}_{m 1} \\ {F}_{2} = {F}_{t 1} {R}_{12} + {F}_{t 2} {R}_{22} + … + {F}_{tm} {R}_{m 2} \\ ⋮ \\ {F}_{n} = {F}_{t 1} {R}_{1 n} + {F}_{t 2} {R}_{2 n} + … + {F}_{tm} {R}_{n 1} \qquad [ Equation 2 ]$$

in the above Equation 2, Fₙ is magnitude of pressure detected in the plurality of pressure detectors, Fₜₘ is magnitude of pressure at positions to which a plurality of pressures are applied, and R_{xy} is a ratio defined by a distance between an x-th pressure detection position and a y-th pressure detector according to the following Equation 3,

$${R}_{xy} = \frac{\frac{1}{{d}_{xy}}}{\frac{1}{{d}_{x 1}} + \frac{1}{{d}_{x 2}} + … + \frac{1}{{d}_{xy}}} \qquad [ Equation 3 ]$$

in the above Equation 3, d_{xy} is a distance between the x-th pressure detection position and the y-th pressure detector.

According to another exemplary embodiment of the present invention, there is provided electronic apparatus detecting touch pressure, including: a touch screen detecting pressure applied by a user's touch to recognize a touch position and a magnitude of pressure applied thereto; and a display displaying images adjusted according to the touch position and the magnitude of pressure recognized by the touch screen, wherein the touch screen includes: a touch pad having pressure applied thereto; a plurality of pressure detectors detecting the pressure applied to the touch pad at different positions; and a touch pressure calculator calculating magnitude of pressure applied to a touch position using distances between the touch position calculated by a difference in detection time of the pressure detected by each of the plurality of pressure detectors and each of the plurality of pressure detectors.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block configuration diagram showing a touch screen apparatus capable of detecting touch pressure according to an exemplary embodiment of the present invention;

FIG. 2 is a diagram for explaining a case in which one touch is applied to a touch screen apparatus according to an exemplary embodiment of the present invention;

FIG. 3 is a diagram for explaining a case in which two touches are applied to a touch screen apparatus according to an exemplary embodiment of the present invention; and

FIGS. 4, 5A to 5C, 6, 7A to 7C, and 8A to 8C are diagrams showing an application example of an electronic apparatus according to another exemplary embodiment of the present invention.

### DETAILED DESCRIPTION OF THE PREFERRED EMBODIMENT

Hereinafter, various exemplary embodiments of the present invention will be described with reference to the accompanying drawings. However, the exemplary embodiments of the present invention may be modified in many different forms and the scope of the invention should not be limited to the embodiments set forth herein. Rather, these exemplary embodiments are provided so that this disclosure will be thorough and complete, and will fully convey the concept of the invention to those skilled in the art. Therefore, it is to be noted that the shape and size of components shown in the drawings may be exaggerated in the interests of clarity.

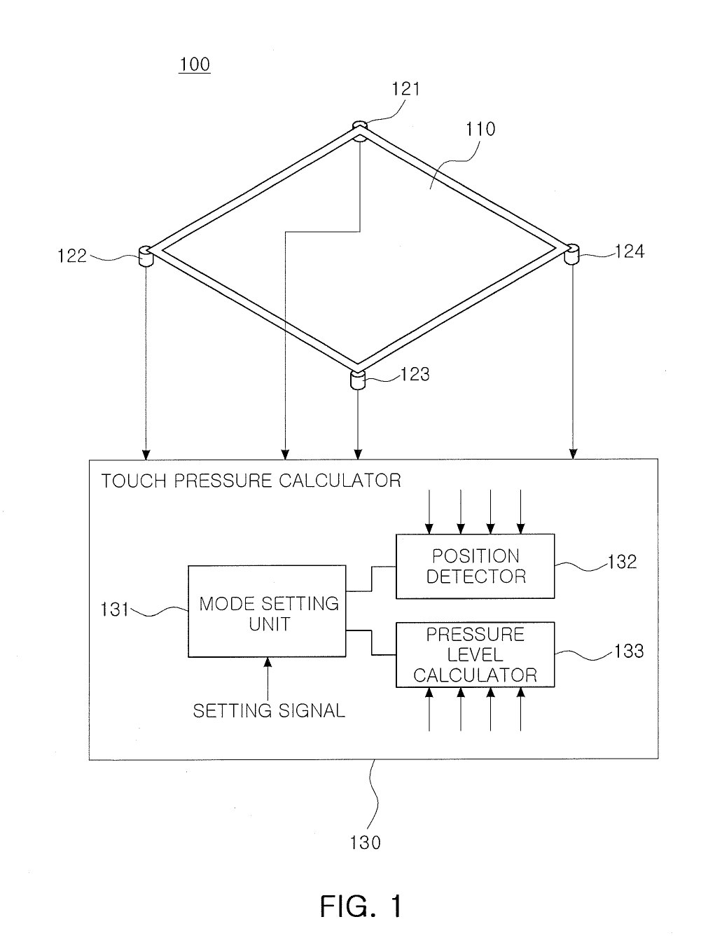

FIG. 1 is a block configuration diagram showing a touch screen apparatus capable of detecting touch pressure according to an exemplary embodiment of the present invention.

As shown in FIG. 1, a touch screen apparatus 100 capable of detecting touch pressure according to an exemplary embodiment of the present invention may be configured to include a touch pad 110, pressure detectors 121 to 124, and a touch pressure calculator 130.

The touch pad 110 may be disposed on a display (screen) on which images are displayed so as to form pressure when being directly touched by a portion of a user's body or an object, such as a stylus. The touch pad 110 may have the touch pressure applied thereto.

The plurality of pressure detectors 121 to 124 may be disposed on a surface within the touch pad 110 opposite to that touched by the user to detect the magnitude of pressure generated by the user's touch.

Each of the plurality of pressure detectors 121 to 124 detects pressure at a different position through contact with the touch pad 110. In the exemplary embodiment of FIG. 1, the touch pad 110 may have a rectangular shape and four pressure detectors 121 to 124 may be disposed at the corners thereof.

As the touch position generated by the user is far from the four pressure detectors 121 to 124, the four pressure detectors 121 to 124 may detect the magnitude of even smaller amounts of pressure.

The touch pressure calculator 130 may recognize a single touch or a plurality of touches according to a preset signal and may calculate the touch position and the magnitude of touch pressure.

To this end, the touch pressure calculator 130 may include a mode setting unit 131, a position detector 132, and a pressure level calculator 133.

The mode setting unit 131 may recognize a single touch or a plurality of touches according to the preset signal. Therefore, the position detector 132 may detect a single touch position or a plurality of touch positions. To this end, the position detector 132 may detect the touch position according to a difference in the time at which the touch pressure reaches the four pressure detectors 121 to 124.

The position detector 132 may determine the coordinates of the position (touch position) to which pressure is applied and the coordinates of the pressure detectors 121 to 124.

The pressure level calculator 133 calculates the magnitude of pressure applied to the touch position using distances between a touch position determined by the position detector 132 and each of the plurality of pressure detectors.

The pressure level calculator 133 receives information on the position to which pressure is applied by the touch of the user and information on the positions of the pressure detectors 121 to 124 from the position detector 132. In addition, the pressure level calculator 133 receives the magnitude of detected pressure from each of the pressure detectors 121 to 124.

The pressure level calculator 133 calculates distances between the position to which pressure is applied and each of the plurality of pressure detectors 121 to 124. The pressure level calculator 133 may calculate the magnitude of pressure at the position at which the pressure is detected by using the fact that the magnitude of pressure detected in a corresponding pressure detector is reduced as the distance between the position to which the pressure is applied and the corresponding pressure detector is increased.

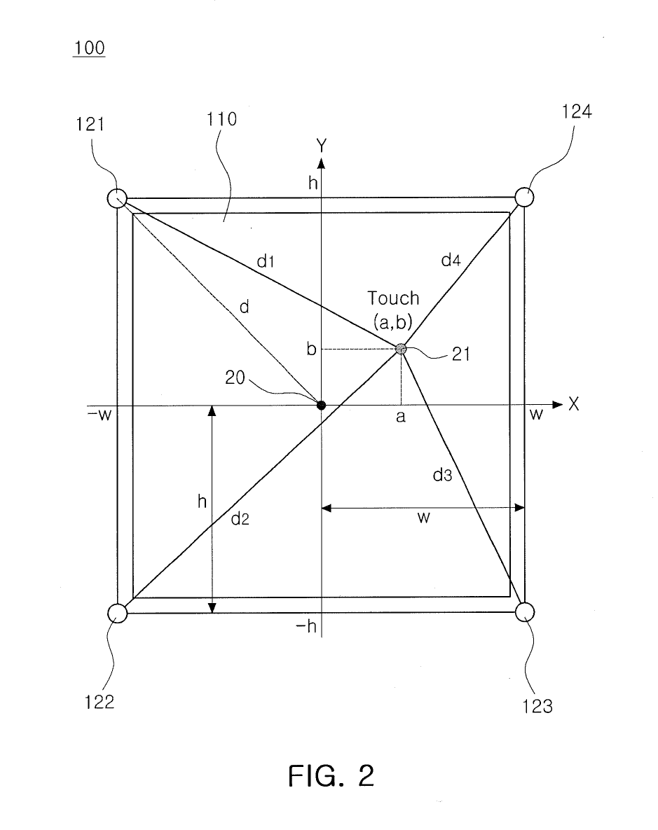

FIG. 2 is a diagram for explaining a case in which one touch is applied to a touch screen apparatus according to an exemplary embodiment of the present invention.

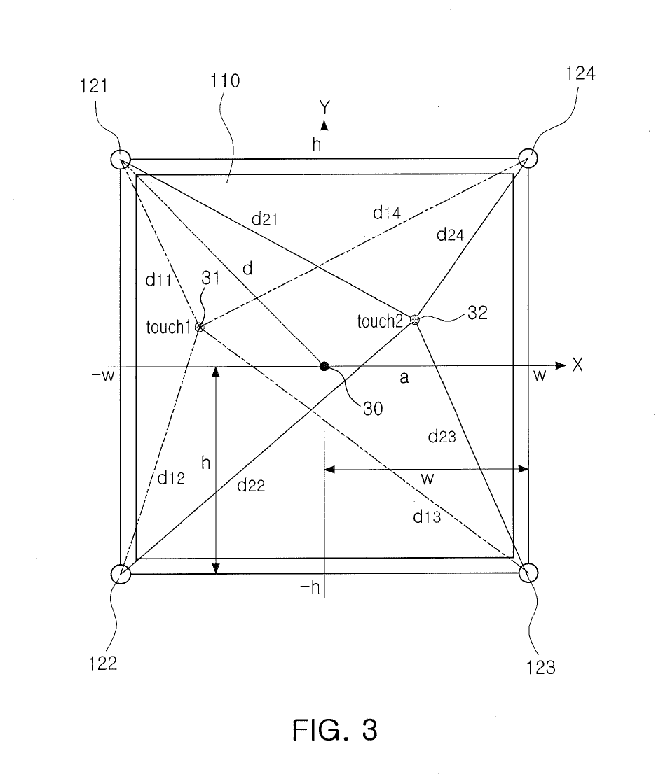

Further, FIG. 3 is a diagram for explaining a case in which two touches are applied to a touch screen apparatus according to an exemplary embodiment of the present invention.

Hereinafter, the operation and effect of the touch screen apparatus capable of detecting the touch pressure according to the exemplary embodiment of the present invention will be described with reference to the accompanying drawings.

Referring to FIG. 2, the position detector 132 may use a center 20 of the touch pad 110 as an original point and set a coordinate plane having coordinate axes formed in parallel with a horizontal side and a vertical side of the touch pad 110.

In addition, the position detector 132 may determine a position 21 to which pressure is applied by the touch and coordinates of the plurality of pressure detectors 121 to 124 on the coordinate plane.

Then, the pressure level calculator 133 may calculate distances between each of the plurality of pressure detectors 121 to 124 and the position 21 to which pressure is applied (hereinafter, referred to as ‘pressure application position’), based on the coordinates determined by the position detector 132.

Next, the pressure level calculator 133 perform a calculation of estimating the pressure applied to the pressure application position 21 by using the distances between the pressure application position 21 and each of the pressure detectors 121 to 124 and the magnitude of pressure detected by each of the pressure detectors 121 to 124.

For example, assuming that, as shown in FIG. 2, the pressure application position is an original point and all of the pressure detectors 121 to 124 are positioned at the same distance d from the original point, all the pressure detectors detect the same magnitude of pressure. In this case, it is assumed that the detected pressure is detected by dividing the pressure applied to each of the pressure detectors from the pressure application position and the pressure detected by the pressure detectors is in inverse proportion to the distance, that is, in proportion to the reciprocal number of the distance. In this case, the pressure detected by each pressure detector 121 to 124 and the pressure at the pressure application position 21 may be estimated according to the following Equation 4.

$${F}_{1} = \frac{\frac{1}{{d}_{1}}}{\frac{1}{{d}_{1}} + \frac{1}{{d}_{2}} + \frac{1}{{d}_{3}} + \frac{1}{{d}_{4}}} {F}_{t} , \\ {F}_{2} = \frac{\frac{1}{{d}_{2}}}{\frac{1}{{d}_{1}} + \frac{1}{{d}_{2}} + \frac{1}{{d}_{3}} + \frac{1}{{d}_{4}}} {F}_{t} , \\ {F}_{3} = \frac{\frac{1}{{d}_{1}}}{\frac{1}{{d}_{3}} + \frac{1}{{d}_{2}} + \frac{1}{{d}_{3}} + \frac{1}{{d}_{4}}} {F}_{t} , \\ {F}_{4} = \frac{\frac{1}{{d}_{4}}}{\frac{1}{{d}_{1}} + \frac{1}{{d}_{2}} + \frac{1}{{d}_{3}} + \frac{1}{{d}_{4}}} {F}_{t} \qquad [ Equation 4 ]$$

In the above Equation 4, Fₜ is the magnitude of pressure estimated at the pressure application position and F₁ to F₄ are the magnitude of pressure detected at the pressure detectors 121 to 124.

Therefore, using one of four Equations included in the above Equation 4, the pressure at the pressure application position 21 may be calculated according to Equation 1.

That is, when a single pressure application position is present on the touch pad 110 and the number of the pressure detector is n (n is a natural number of 2 or more), the magnitude of pressure applied to the touch position may be calculated by the following Equation 1.

$${F}_{t} = \frac{\frac{1}{{d}_{1}} + \frac{1}{{d}_{2}} + … + \frac{1}{{d}_{n}}}{\frac{1}{{d}_{k}}} {F}_{k} \qquad [ Equation 1 ]$$

In the above Equation 1, Fₜ is the magnitude of pressure applied to the touch position, d₁ to dₙ are the distances between the touch position and each of the pressure detectors, k is any number between 1 to n, Fₖ is the magnitude of pressure detected by any pressure detector, and dₖ is the distance between any pressure detector and the touch position.

FIG. 3 is a diagram for explaining a case in which two touches are applied to a touch screen apparatus according to an exemplary embodiment of the present invention.

Similarly to FIG. 2, the position detector 132 may use the center 30 of the touch pad 110 as an original point and set a coordinate plane having coordinate axes formed in parallel with a horizontal side and a vertical side of the touch pad 110.

In addition, the position detector 132 may determine two points 31 and 32 to which pressure is applied by the touch and the coordinates of the plurality of pressure detectors 121 to 124 on the coordinate plane.

Then, the pressure level calculator 133 may calculate distances between each of the plurality of pressure detectors 121 to 124 and each of the pressure application points 31 and 32, based on the coordinates detected by the position detector 132.

Next, the pressure level calculator 133 may perform a calculation of estimating the pressure applied to the pressure application positions 31 and 32 by using the distances between each of the pressure application points 31 and 32 and each of the pressure detectors 121 to 124 and the magnitude of pressure detected by each of the pressure detectors 121 to 124.

The assumption of the relationship between the pressure detected by the pressure detectors and the pressure application position, which is already described in FIG. 2, may also be applied to the pressure estimation at the pressure application positions when the plurality of pressure application positions are generated. However, when the plurality of pressure application positions are generated, the pressure applied to the each of the pressure detectors 121 to 124 is calculated by estimating the sum of pressure at the plurality of pressure application positions.

Therefore, as in the following Equation 5, the pressure detected in each of the pressure detectors 121 to 124 may be determined.

F₁=Fₜ₁R₁₁+Fₜ₂R₂₁

F₂=Fₜ₁R₁₂+Fₜ₂R₂₂

F₃=Fₜ₁R₁₃+Fₜ₂R₂₃

F₄=Fₜ₁R₁₄+Fₜ₂R₂₄ [Equation 5]

In the above Equation 5, Fₜ₁ to Fₜ₂ each are the magnitude of estimated pressure at the two pressure application positions 31 and 32, R_{xy} (in the Equation 5, x is 1 or 2 and y is 1 to 4) represents a ratio determined by the distances between each of the pressure application positions 31 and 32 and each of the pressure detectors 121 to 124 as the following Equation 6.

$${R}_{xy} = \frac{\frac{1}{{d}_{xy}}}{\frac{1}{{d}_{x 1}} + \frac{1}{{d}_{x 2}} + … + \frac{1}{{d}_{xy}}} \qquad [ Equation 6 ]$$

In Equation 6, x corresponds to the number of detected positions and y corresponds to the number of pressure detectors.

The above Equation 5 is an equation with two unknowns to calculate the two unknowns, i.e., Fₜ₁ to Fₜ₂, and may calculate the pressure Fₜ₁ to Fₜ₂ at two pressure detection positions 31 and 32 by selecting two of the four Equations.

Generalizing the process of detecting pressure generated by a plurality of touches according to Equations 5 and 6 may be as follows.

The touch pressure calculator may calculate the pressure at the pressure application position by a plural equation of the following Equation 2 when the number of the pressure application positions are m (m is a natural number of 2 or more) and the number of the pressure detector is n (n is a natural number of 2 or more)

$${F}_{1} = {F}_{t 1} {R}_{11} + {F}_{t 2} {R}_{21} + … + {F}_{tm} {R}_{m 1} \\ {F}_{2} = {F}_{t 1} {R}_{12} + {F}_{t 2} {R}_{22} + … + {F}_{tm} {R}_{m 2} \\ ⋮ \\ {F}_{n} = {F}_{t 1} {R}_{1 n} + {F}_{t 2} {R}_{2 n} + … + {F}_{tm} {R}_{n 1} \qquad [ Equation 2 ]$$

In the above Equation 2, Fₙ is the magnitude of pressure detected in the plurality of pressure detectors, Fₜₘ is the magnitude of pressure at the position to which the plurality of pressures are applied, and R_{xy} is a ratio defined by the distance between an x-th pressure detection position and a y-th pressure detector according to the following Equation 3.

$${R}_{xy} = \frac{\frac{1}{{d}_{xy}}}{\frac{1}{{d}_{x 1}} + \frac{1}{{d}_{x 2}} + … + \frac{1}{{d}_{xy}}} \qquad [ Equation 3 ]$$

In the above Equation 3, d_{xy} is the distance between the x-th pressure detection position and the y-th pressure detector.

In order to obtain a solution of the plural equation of Equation 2, the number m of positions to which pressure is applied is equal to or less than the number n of pressure detectors.

The above-mentioned touch screen apparatus may be applied to an electronic apparatus, in particular, to a game machine.

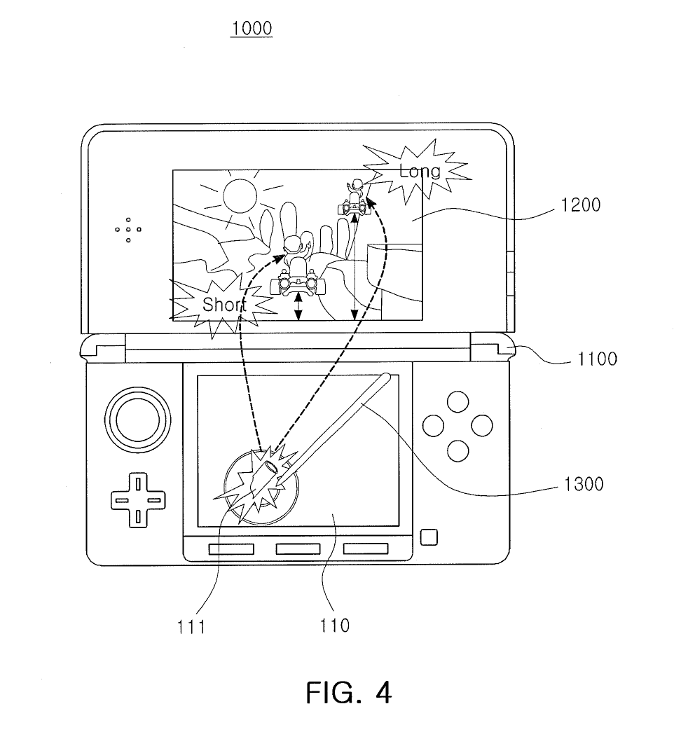

FIGS. 4, 5A to 5C, 6, 7A to 7C, and 8A to 8C are diagrams showing an application example of an electronic apparatus according to another exemplary embodiment of the present invention.

Referring to FIG. 4, a portion of a main body 1100 of an electronic apparatus 1000 may be formed to have a display 1200 on which images are displayed and the other portion of the main body 1100 thereof may be formed to have the touch pad 110 of the touch screen apparatus capable of adjusting images displayed on the display 1200. As described above, the bottom surface of the touch pad 110 is provided with a screen on which images are displayed to thereby display an image 111 on a specific position thereof, a stylus 1300 touches the position of the corresponding image 111 to adjust the image displayed on the display 1200 according to the magnitude of the touch pressure. By way of example, the image displayed on the display 1200 may fly away or slightly fly according to the magnitude of pressure touching the image displayed on a display 1200.

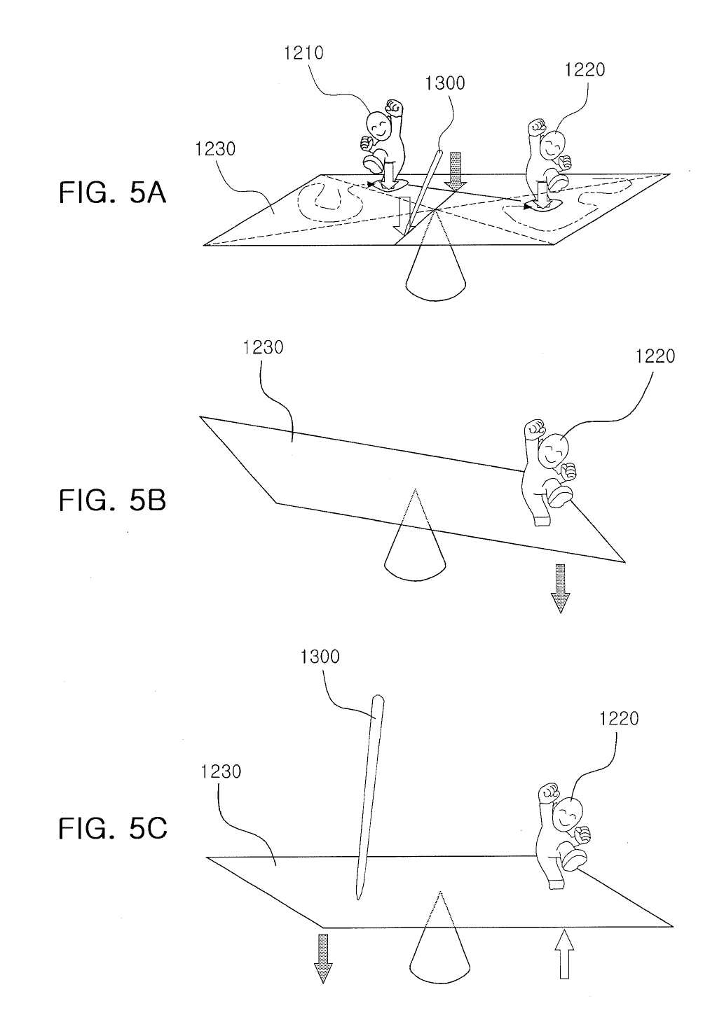

Further, referring to FIGS. 5A to 5C, when a game is implemented, in which images 1210 and 1220 representing characters are positioned on an image 1230 representing a plane having a predetermined width to be balanced, the images 1210 and 1220 representing characters by the touch of the stylus 1300 moves or the degree of force for balance may be adjusted according to the magnitude of pressure of the stylus 1300.

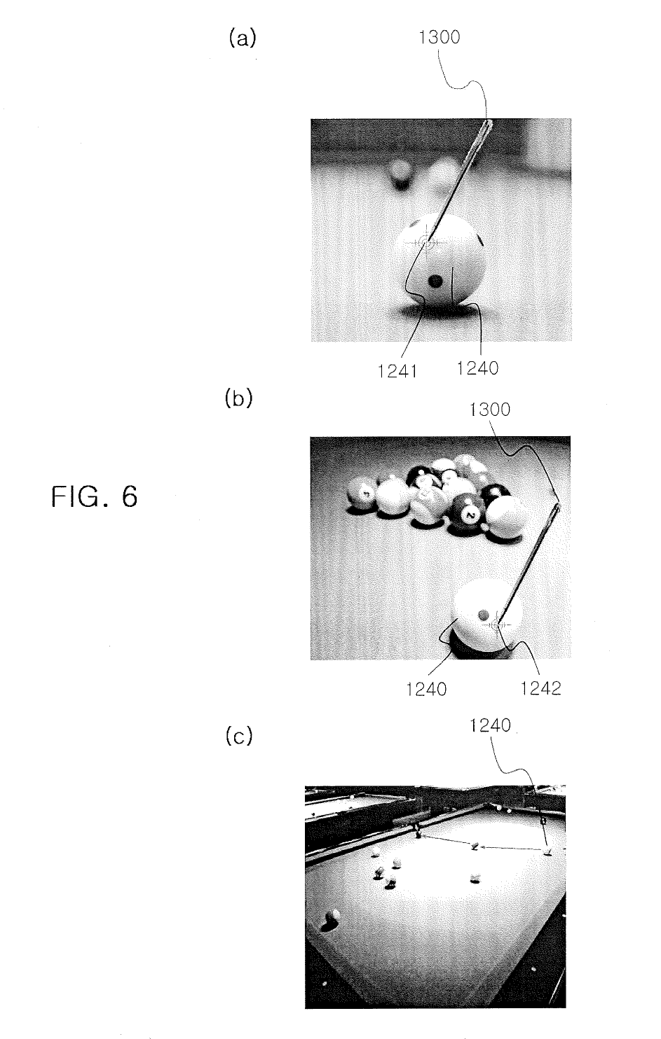

Further, referring to FIGS. 6A to 6C, when a billiards game is implemented, a position of impact points 1241 and 1242 of a ball 1240 and the degree of force applied to the impact points 1241 and 1242 may be adjusted according to the touch position and the touch pressure of the stylus 1300.

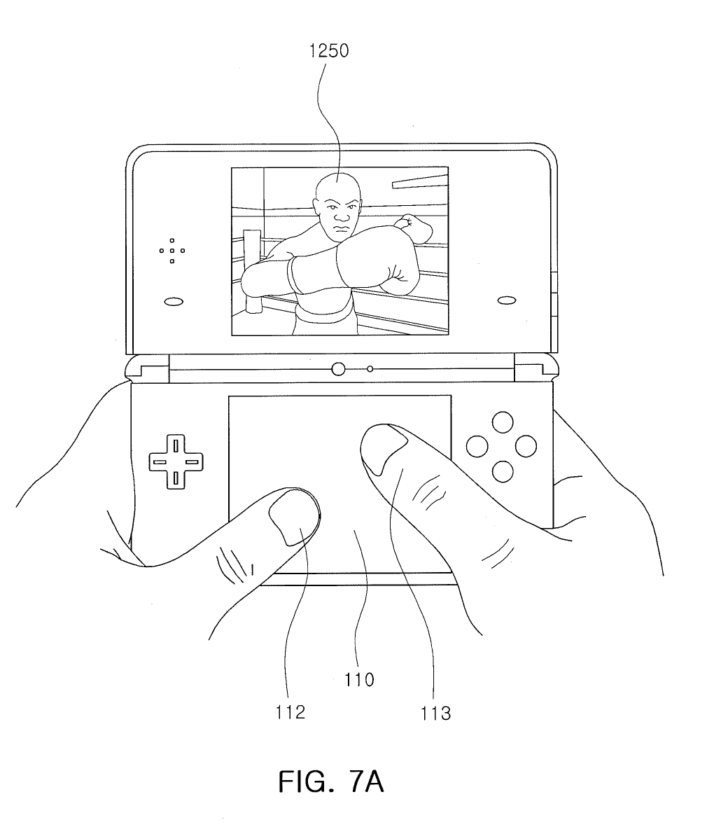

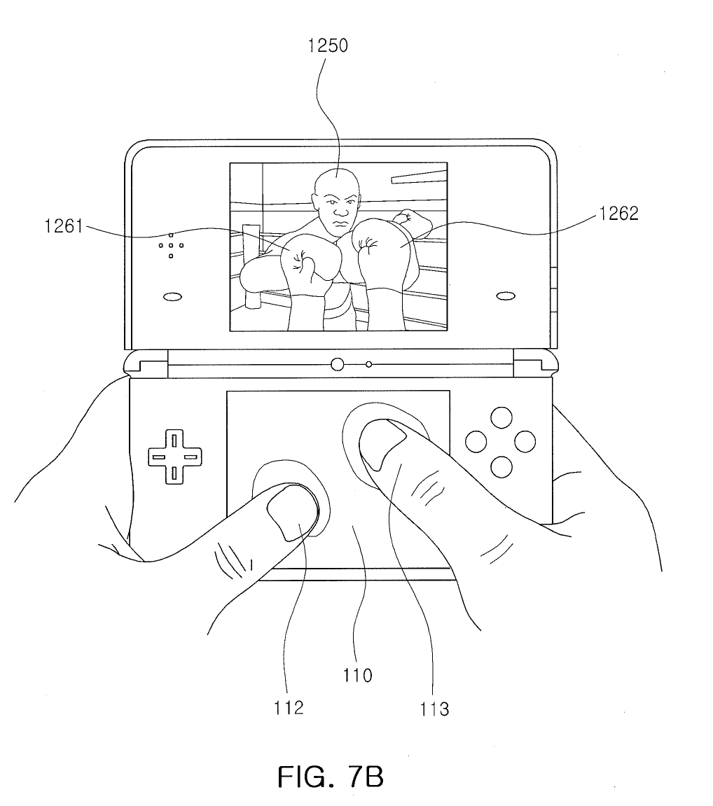

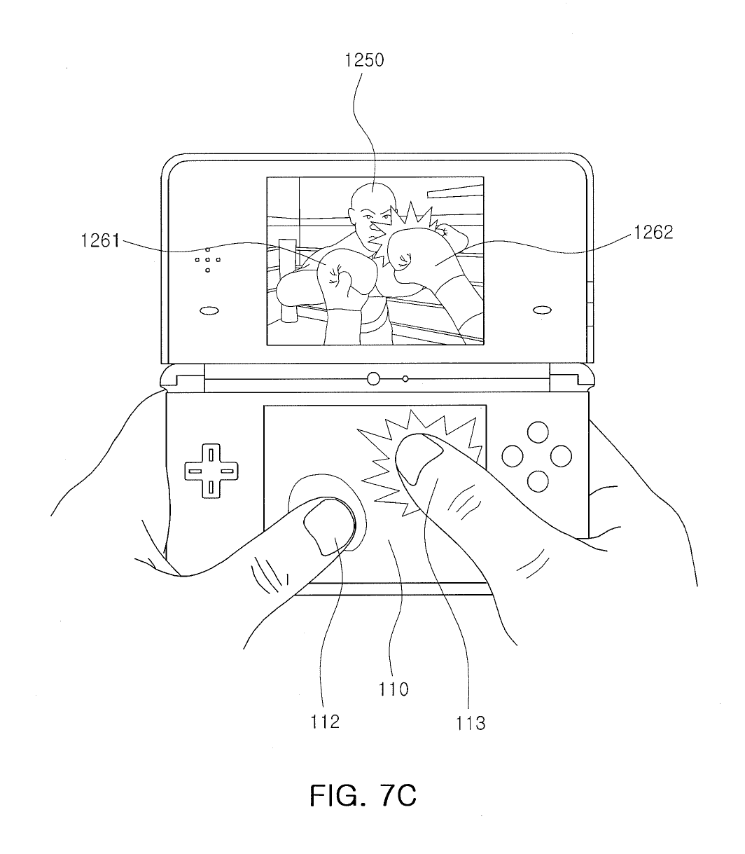

In addition, referring to FIGS. 7A to 7C, in the case of a boxing game, two fingers 112 and 113 are positioned on the touch pad 110 and simultaneously touch portions or strongly touch one of the portions on the touch pad 110 to block 1261 and 1262 a punch of an opponent 1250 or to throw 1262 a punch at the opponent.

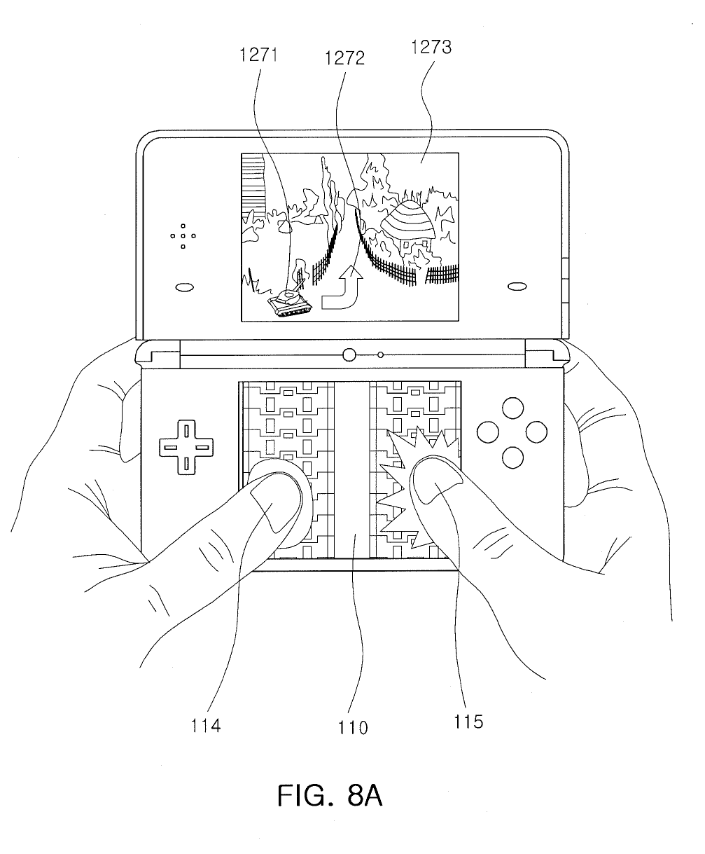

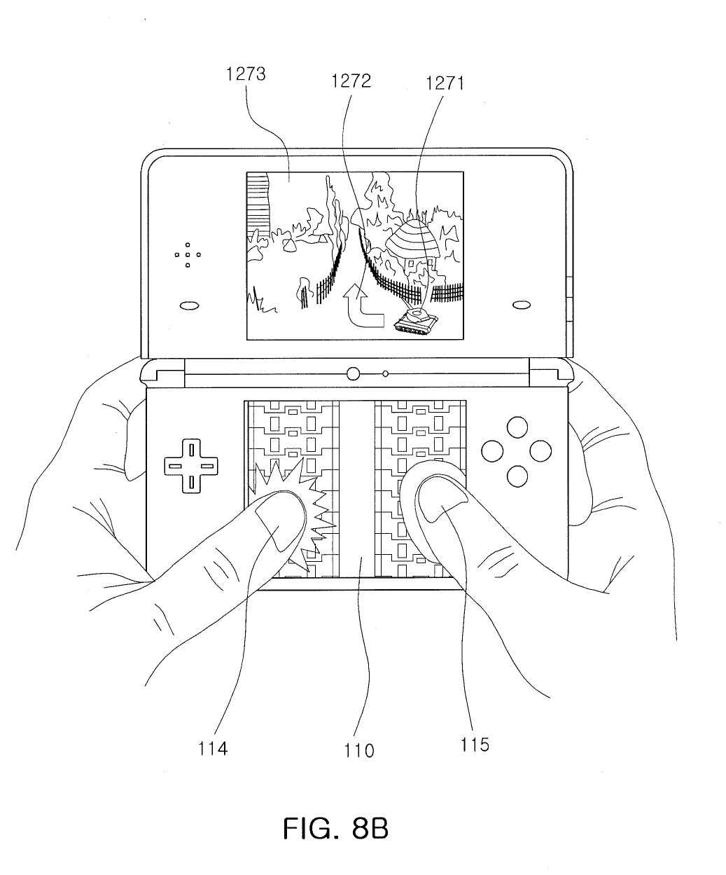

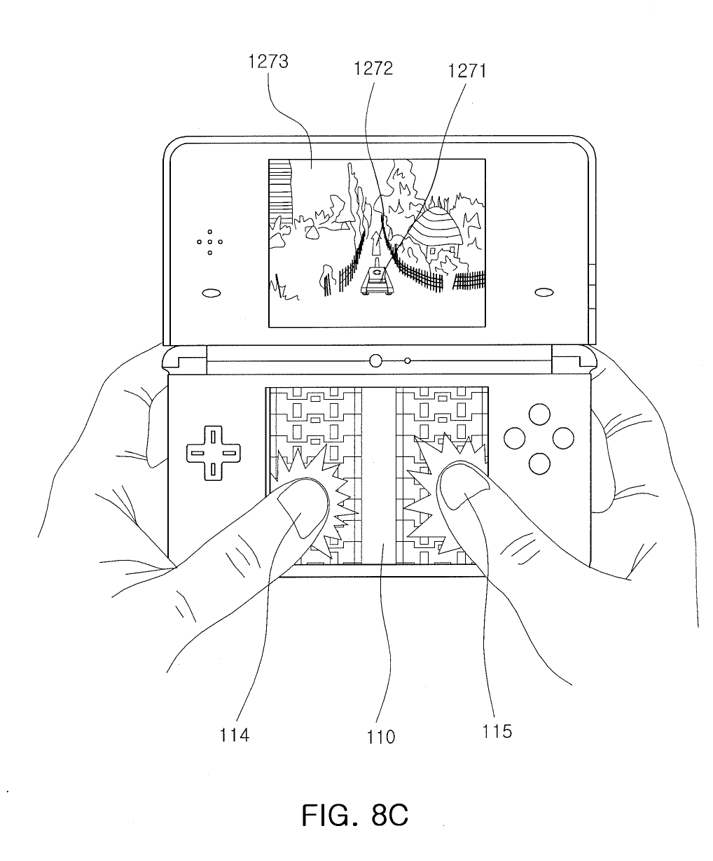

In addition, referring to FIGS. 8A to 8C, in the case of a game of adjusting a tank, two fingers 114 and 115 are positioned on the touch pad 110 and simultaneously touch the touch pad 110 or strongly touch a portion of the touch pad 110 to adjust and move the tank 1271 in a desired direction 1272 in a game 1273.

As described above, according to the exemplary embodiments of the present invention, the touch position on the touch pad are detected and pressure are detected by separate plural pressure detection sensors, whereby the touch position inputted by the user on the touch screen and the magnitude of pressure applied by the touch at the touch position may be calculated.

According to characteristics of the present invention, various applications (for example, a game, or the like) using the magnitude of pressure applied to the touch screen may be implemented.

As set forth above, according to the exemplary embodiment of the present invention, the touch position inputted by the user on the touch screen and the magnitude of pressure applied by the touch at the touch position may be calculated.

As a result, in the exemplary embodiments of the present invention various applications using the magnitude of pressure applied to the touch screen may be implemented.

While the present invention has been shown and described in connection with the exemplary embodiments, it will be apparent to those skilled in the art that modifications and variations can be made without departing from the spirit and scope of the invention as defined by the appended claims.

What is claimed is:

1. A touch screen apparatus detecting touch pressure, comprising:
a touch pad having pressure applied thereto;
a plurality of pressure detectors detecting the pressure applied to the touch pad at different positions; and
a touch pressure calculator calculating magnitude of pressure applied to a touch position using distances between the touch position calculated by a difference in detection time of the pressure detected by each of the plurality of pressure detectors and each of the plurality of pressure detectors.

2. The touch screen apparatus of claim 1, wherein the touch pressure calculator includes:
a mode setting unit setting a single mode calculating magnitude of a single touch pressure or a multi-mode calculating magnitude of a plurality of touch pressures according to a setting signal;
a position detector detecting a single touch position or a plurality of touch positions according to the set mode of the mode setting unit; and
a pressure level calculator calculating the magnitude of the single touch pressure or the magnitude of the plurality of touch pressures by using distances between the single touch position or the plurality of touch positions and each of the plurality of pressure detectors according to the set mode of the mode setting unit.

3. The touch screen apparatus of claim 2, wherein the pressure level calculator calculates the magnitude of pressure applied to the touch position by the following Equation 1 when the number of pressure application positions is one and the number of the pressure detector is n (n is a natural number of 2 or more);
$${F}_{t} = \frac{\frac{1}{{d}_{1}} + \frac{1}{{d}_{2}} + … + \frac{1}{{d}_{n}}}{\frac{1}{{d}_{k}}} {F}_{k} \qquad [ Equation 1 ]$$
in the above Equation 1, Fₜ is the magnitude of pressure applied to the touch position, d₁ to dₙ are distances between the touch position and each of the pressure detectors, k is any number between 1 to n, Fₖ is magnitude of pressure detected by any pressure detector, and dₖ is a distance between any pressure detector and the touch position.

4. The touch screen apparatus of claim 2, wherein the pressure level calculator calculates pressure at pressure application positions by a plural equation of the following Equation 2 when the number of the pressure application positions are m (m is a natural number of 2 or more) and the number of the pressure detector is n (n is a natural number of 2 or more);
$${F}_{1} = {F}_{t 1} {R}_{11} + {F}_{t 2} {R}_{21} + … + {F}_{tm} {R}_{m 1} \\ {F}_{2} = {F}_{t 1} {R}_{12} + {F}_{t 2} {R}_{22} + … + {F}_{tm} {R}_{m 2} \\ ⋮ \\ {F}_{n} = {F}_{t 1} {R}_{1 n} + {F}_{t 2} {R}_{2 n} + … + {F}_{tm} {R}_{n 1} \qquad [ Equation 2 ]$$
in the above Equation 2, Fₙ is magnitude of pressure detected in the plurality of pressure detectors, Fₜₘ is magnitude of pressure at positions to which a plurality of pressures are applied, and R_{xy} is a ratio defined by a distance between an x-th pressure detection position and a y-th pressure detector according to the following Equation 3,
$${R}_{xy} = \frac{\frac{1}{{d}_{xy}}}{\frac{1}{{d}_{x 1}} + \frac{1}{{d}_{x 2}} + … + \frac{1}{{d}_{xy}}} \qquad [ Equation 3 ]$$
in the above Equation 3, d_{xy} is a distance between the x-th pressure detection position and the y-th pressure detector.

5. An electronic apparatus detecting touch pressure, comprising:
a touch screen detecting pressure applied by a user's touch to recognize a touch position and a magnitude of pressure applied thereto; and
a display displaying images adjusted according to the touch position and the magnitude of pressure recognized by the touch screen,
wherein the touch screen includes:
a touch pad having pressure applied thereto;
a plurality of pressure detectors detecting the pressure applied to the touch pad at different positions; and
a touch pressure calculator calculating magnitude of pressure applied to a touch position using distances between the touch position calculated by a difference in detection time of the pressure detected by each of the plurality of pressure detectors and each of the plurality of pressure detectors.

6. The electronic apparatus of claim 5, wherein the touch pressure calculator includes:
a mode setting unit setting a single mode calculating magnitude of a single touch pressure or a multi-mode calculating magnitude of a plurality of touch pressures according to a setting signal;
a position detector detecting a single touch position or a plurality of touch positions according to the set mode of the mode setting unit; and
a pressure level calculator calculating the magnitude of the single touch pressure or the magnitude of the plurality of touch pressures using distances between the single touch position or the plurality of touch positions and each of the plurality of pressure detectors according to the set mode of the mode setting unit.

7. The electronic apparatus of claim 6, wherein the pressure level calculator calculates the magnitude of pressure applied to the touch position by the following Equation 1 when the number of pressure application positions is one and the number of the pressure detector is n (n is a natural number of 2 or more);
$${F}_{t} = \frac{\frac{1}{{d}_{1}} + \frac{1}{{d}_{2}} + … + \frac{1}{{d}_{n}}}{\frac{1}{{d}_{k}}} {F}_{k} \qquad [ Equation 1 ]$$
in the above Equation 1, Fₜ is the magnitude of pressure applied to the touch position, d₁ to dₙ, are distances between the touch position and each of the pressure detectors, k is any number between 1 to n, Fₖ is magnitude of pressure detected by any pressure detector, and dₖ is a distance between any pressure detector and the touch position.

8. The electronic apparatus of claim 6, wherein the pressure level calculator calculates pressure at pressure application positions by a plural equation of the following Equation 2 when the number of the pressure application positions are m (m is a natural number of 2 or more) and the number of the pressure detector is n (n is a natural number of 2 or more);
$${F}_{1} = {F}_{t 1} {R}_{11} + {F}_{t 2} {R}_{21} + … + {F}_{tm} {R}_{m 1} \\ {F}_{2} = {F}_{t 1} {R}_{12} + {F}_{t 2} {R}_{22} + … + {F}_{tm} {R}_{m 2} \\ ⋮ \\ {F}_{n} = {F}_{t 1} {R}_{1 n} + {F}_{t 2} {R}_{2 n} + … + {F}_{tm} {R}_{n 1} \qquad [ Equation 2 ]$$
in the above Equation 2, Fₙ, is magnitude of pressure detected in the plurality of pressure detectors, Fₜₘ, is magnitude of pressure at positions to which a plurality of pressures are applied, and R_{xy} is a ratio defined by a distance between an x-th pressure detection position and a y-th pressure detector according to the following Equation 3,
$${R}_{xy} = \frac{\frac{1}{{d}_{xy}}}{\frac{1}{{d}_{x 1}} + \frac{1}{{d}_{x 2}} + … + \frac{1}{{d}_{xy}}} \qquad [ Equation 3 ]$$
in the above Equation 3, d_{xy} is a distance between the x-th pressure detection position and the y-th pressure detector.
